(19) United States
(12) Patent Application Publication
(10) Pub. No.: US 2015/0001010 A1
(43) Pub. Date: Jan. 1, 2015

(54) ELECTRIC PARKING CALIPER

(71) Applicant: Chih-Hsien Liao, Taichung City (TW)

(72) Inventor: Chih-Hsien Liao, Taichung City (TW)

(21) Appl. No.: 13/927,810

(22) Filed: Jun. 26, 2013

(51) Int. Cl. B60T 1/06; F16D 65/00; B60T 13/74

(52) U.S. Cl. CPC B60T 1/065; B60T 13/743; F16D 65/0068
USPC 188/72.3

(57) ABSTRACT

An electric parking caliper is adapted to connect with a brake disk. The brake disk has first and second side surfaces perpendicular to an axis. The electric parking caliper includes first and second brake linings, first and second driving members movable along a central line parallel to the axis, a plurality of driving rods connected between the first and second driving members and parallel to the axis, and an actuating shaft. The actuating shaft is movable for driving movement of the first driving member along the central line so as to move the first brake lining toward or away from the first end surface, and for activating the driving rods to move the second driving member along the central line so as to move the second brake lining toward or away from the second end surface.

### BACKGROUND OF THE INVENTION

1. Field of the Invention

This invention relates to a braking system, and more particularly to an electric parking caliper.

2. Description of the Related Art

A conventional parking caliper device for use with a vehicle tire includes brake linings, which may be controlled hydraulically or manually. In the case of hydraulic control, the parking caliper device needs to include oil cylinders, pistons, and conduits, etc., resulting in a complicated structure and an increased manufacturing cost. In the case of manual control, the parking caliper device is troublesome to operate.

### SUMMARY OF THE INVENTION

The object of this invention is to provide an electric parking caliper that has a simple structure and that is convenient and easy to operate.

According to this invention, an electric parking caliper is adapted to connect with a brake disk. The brake disk has opposite first and second side surfaces perpendicular to an axis. The electric parking caliper includes first and second brake linings, first and second driving members movable along a central line parallel to the axis, a plurality of driving rods connected between the first and second driving members and parallel to the axis, and an actuating shaft. The actuating shaft is movable for driving movement of the first driving member along the central line so as to move the first brake lining toward or away from the first end surface, and for activating the driving rods to move the second driving member along the central line so as to move the second brake lining toward or away from the second end surface.

As such, through operation of only the actuator, the actuating shaft is activated to move the first driving member and the first brake lining toward the first end surface, to thereby allow the second driving member and the second bake lining to be moved toward the second end surface by the driving rods. Such an operation is relatively convenient and easy.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 a partly exploded perspective view of the preferred embodiment of an electric parking caliper according to this invention;

FIG. 2 is a perspective view of the preferred embodiment, illustrating that the electric parking caliper is connected to a brake disk;

FIG. 3 is a sectional view of the preferred embodiment, illustrating a non-braking state of the electric parking caliper;

FIG. 4 is a view similar to FIG. 3 but illustrating how a first brake lining is moved by a first driving member to press against the brake disk; and

FIG. 5 is a view similar to FIG. 3 but illustrating how a second brake lining is moved by a second driving member to press against the brake disk.

### DETAILED DESCRIPTION OF THE PREFERRED EMBODIMENT

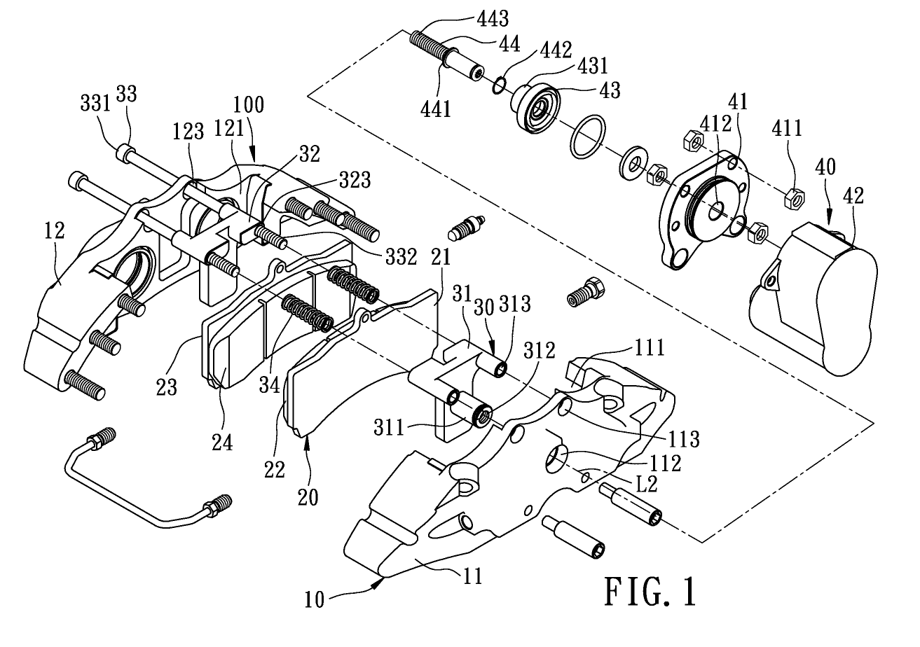

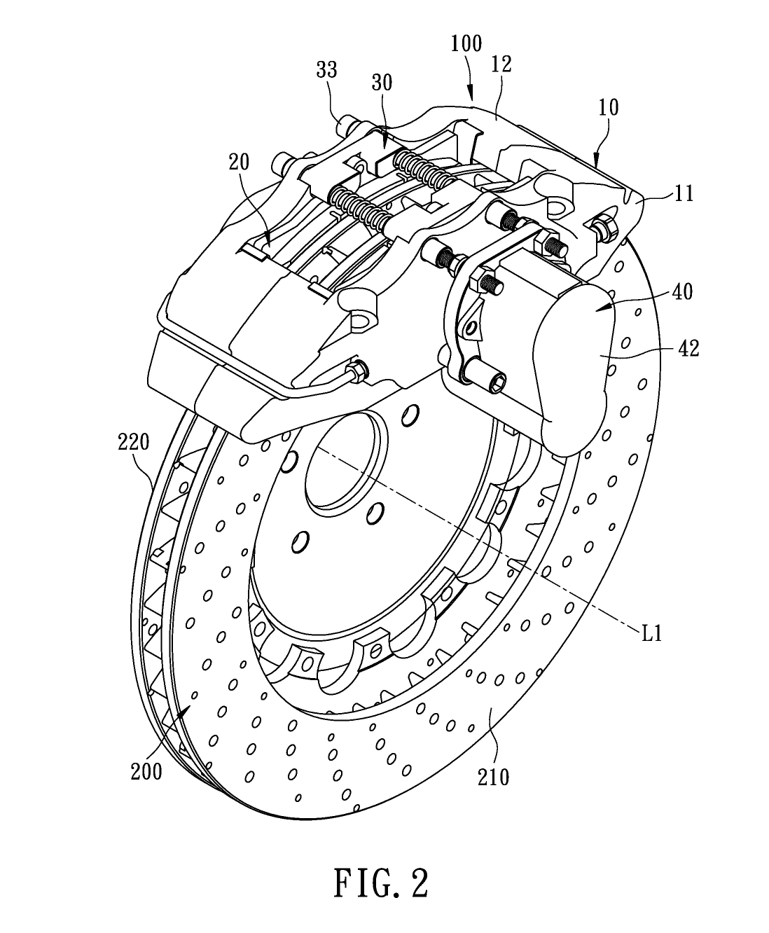

FIGS. 1, 2, and 3, the first preferred embodiment of an electric parking caliper 100 according to this invention is adapted to use with a brake disk 200 of a vehicle (not shown). The brake disk 200 has a first end surface 210 and a second end surface 220 opposite to the first end surface 210. The first and second end surfaces 210, 220 are perpendicular to an axis (L1). The electric parking caliper 100 includes a caliper body unit 10, a brake lining unit 20, a driving unit 30, and an actuating unit 40.

The caliper body unit 10 includes a first side member 11 corresponding to the first end surface 210, and a second side member 12 corresponding to the second end surface 220 and connected fixedly to the first side member 11. The first side member 11 has a first groove 111 disposed in proximity to the first end surface 210, an axial hole 112 formed through the first side member 11 and in spatial communication with the first groove 111, and two first through holes 113 adjacent to the axial hole 112. The second side member 12 has a second groove 121 disposed in proximity to the second end surface 220, and two second through holes 123 aligned respectively with the first through holes 113.

The brake lining unit 20 includes a first positioning member 21 movable in the first groove 111 along a central line (L2) parallel to the axis (L1), a first brake lining 22 connected fixedly to the first positioning member 21, a second positioning member 23 movable in the second groove 121 along the central line (L2), and a second brake lining 24 connected fixedly to the second positioning member 23. The first and second brake linings 22, 24 are adjacent to the first and second end surfaces 210, 220, respectively.

The driving unit 30 includes a first driving member 31 movable in the first groove 111 along the central line (L2), a second driving member 32 movable in the second groove 121 along the central line (L2), a plurality of driving rods 33 connected between the first and second driving members 31, 32 and parallel to the central line (L2), and a plurality of resilient members 34 for biasing the first and second brake linings 22, 24.

The first driving member 31 is disposed between the first side member 11 and the first positioning member 21, has an insert tube portion 311 extending through the axial hole 112 along the central line (L2), and a threaded hole 312 formed in the insert tube portion 311 and extending along the central line (L2). The first driving member 31 further has two first through holes 313 formed in a top end portion thereof.

The second driving member 32 is disposed between the second side member 12 and the second positioning member 23, and has two second through holes 323 formed in a top end portion thereof and aligned respectively with the first through holes 313.

Each of the driving rods 33 extends through a corresponding one of the first and second through holes 113, 123 in the first and second side members 11, 12 and a corresponding one of the first and second through holes 313, 323 in the first and second driving members 31, 32. In this embodiment, each of the driving rods 33 has an enlarged positioning end 331 positioned on the second driving member 32, and a pulling end 332 opposite to the positioning end 331. The positioning ends 331 abut against the second driving member 32. The pulling ends 332 are externally threaded, and extend from the first through holes 113, respectively.

The resilient members 34 bias the first brake lining 22 away from the first end surface 210, and bias the second brake lining 24 away from the second end surface 220. In this embodiment, the resilient members 34 are configured as compression springs, and are sleeved respectively on the driving rods 33. Each of the resilient members 34 has two ends abutting respectively against the first and second driving members 31, 32.

The actuating unit 40 includes a support 41 connected with the pulling ends 332 of the driving rods 33, an actuator 42 extending through the support 41 and connected with the pulling ends 332 of the driving rods 33, a bushing 43 extending along the central line (L2) and positioned on the support 41, and an actuating shaft 44 extending along the central line (L2) and driven by the actuator 42.

A plurality of nuts 411 engage respectively the pulling ends 332 of the driving rods 33 for locking the support 41 on the driving rods 33. The support 41 has a circular central hole 412.

The actuator 42 is installed on the support 41. In this embodiment, the actuator 42 includes a motor (not shown), a reduction gear (not shown) , and an output shaft 421 driven by the reduction gear and extending into the circular central hole 412.

The bushing 43 has an annular flange 431 extending along the central line (L2), and a shoulder surface 432 located in the annular flange 431. The insert tube portion 311 of the first driving member 31 extend into the annular flange 431.

The actuating shaft 44 extends through the central hole 412 in the support 41, is disposed rotatably within the bushing 43, and has a stop ring portion 441 abutting against the shoulder surface 432 of the bushing 43, a retaining ring 442 sleeved on an end of the actuating shaft 44, and a threaded portion 443 disposed at an opposite end of the actuating shaft 44 and engaging the threaded hole 312. The output shaft 421 has a non-circular cross-section, and extends fittingly into a hole in an end surface of the actuating shaft 44, so as to allow for movement of the actuating shaft 44 relative to the output shaft 421, while preventing rotation of the actuating shaft 44 relative to the output shaft 421 . Since the stop ring portion 441 abuts against the shoulder surface 432 of the bushing 43, and since the retaining ring 442 abuts against the support 41, the actuating shaft 44 is positioned relative to the support 41, the actuator 42, and the bushing 43 along the central line (L2). That is, movement of the actuating shaft 44 relative to the support 41 along the central line (L2) is prevented, while rotation of the actuating shaft 44 relative to the support 41 is allowed.

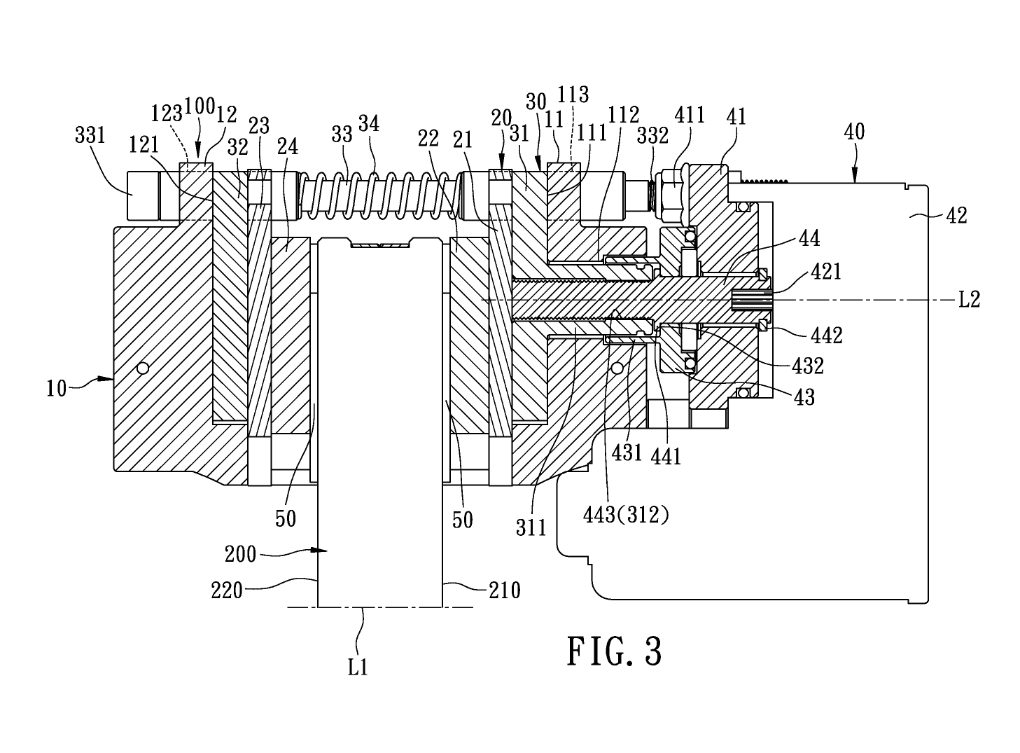

With particular reference to FIG. 3, when the electric parking caliper 100 is assembled to the brake disk 200, a clearance 50 is formed between the first brake lining 22 and the first end surface 210, and between the second brake lining 24 and the second end surface 220. In this case, the brake disk 200 can rotate freely.

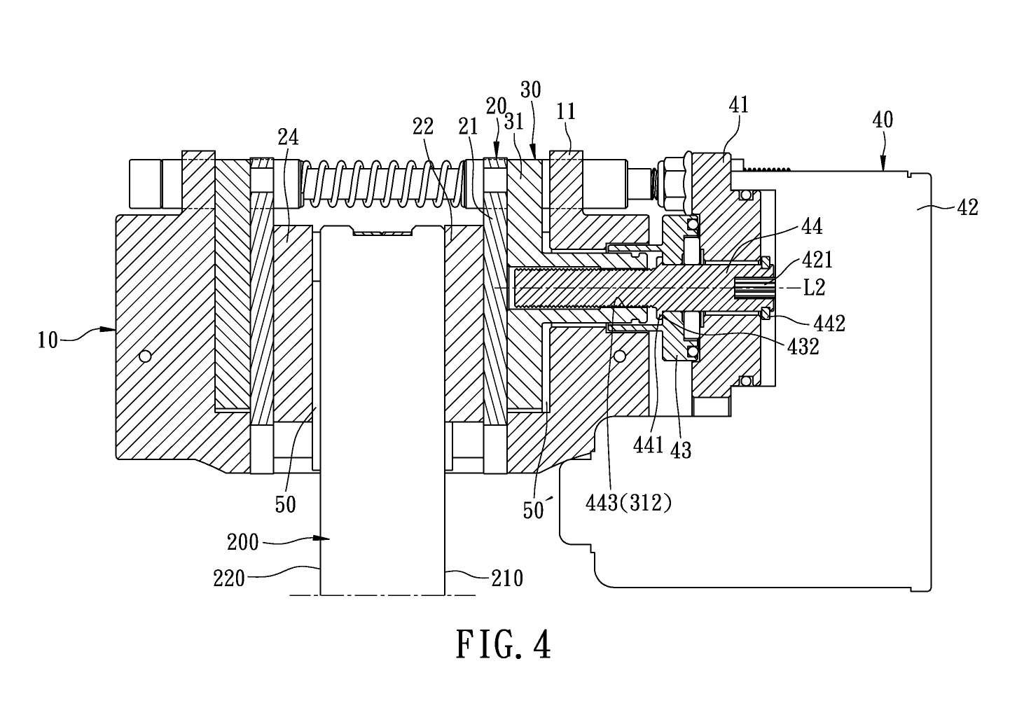

With further reference to FIG. 4, when the vehicle is to be parked, the actuator 42 is actuated so that the output shaft 421 drives rotation of the actuating shaft 44 in a first direction. Hence, due to engagement between the threaded portion 443 of the actuating shaft 44 and the threaded hole 312 in the first driving member 31, the first driving member 32 is moved to push the first brake lining 21 to press against the first end surfaced 210, thereby eliminating the clearance 50 between the first end surface 210 and the first brake lining 21 and forming a clearance 50′ between the first side member 11 and the first driving member 31. At the same time, since the second brake lining 24 is not moved, the clearance 50 remains between the second brake lining 24 and the second end surface 220.

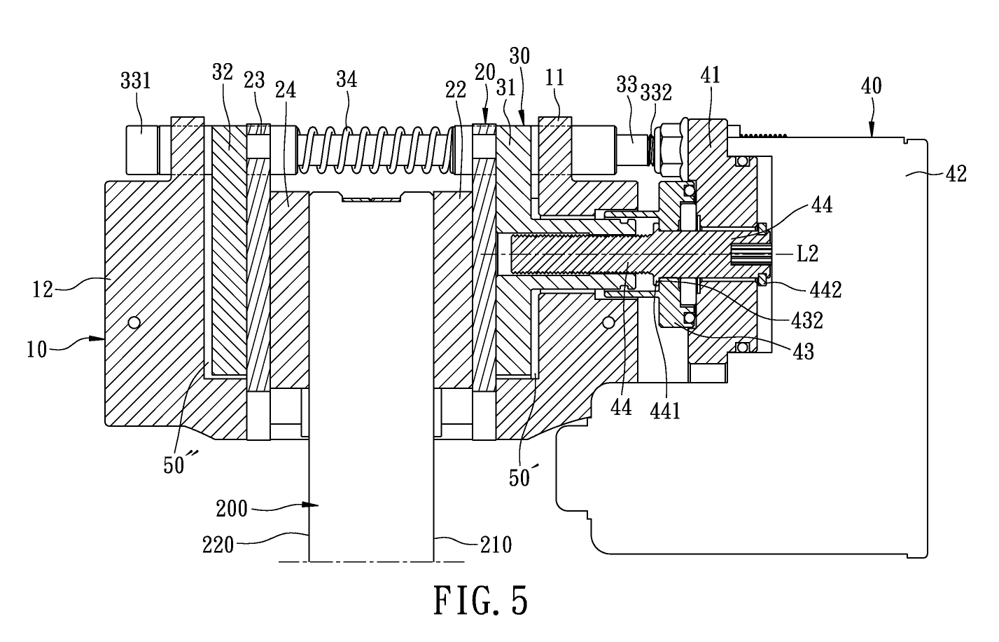

With further reference to FIG. 5, when operation of the actuator 42 is continued, since the first driving member 31 cannot move relative to the brake disk 200, the actuating shaft 44 and the support 41 are moved relative to the first driving member 31 in a direction away from the brake disk 200. At this time, since the driving rods 33 are connected fixedly to the support 41, they move the second driving member 32 toward the brake disk 200. As a result, the second brake lining 24 is moved by the second driving member 32 to press against the second end surface 220, such that the clearance 50 between the second brake lining 24 and the second end surface 220 is eliminated, and a clearance 50″ is formed between the second side member 12 and the second driving member 32. At this time, since the brake disk 200 is clamped between the first and second brake linings 22, 24, it is braked effectively.

When the actuator 42 is actuated again, the output shaft 421 drives rotation of the actuating shaft 44 in a second direction opposite to the first direction. Hence, the first and second brake linings 22, 24 can be returned to the state shown in FIG. 4. Subsequently, continuous rotation of the actuating shaft 44 results in return of the first and second brake linings 22, 24 from the state shown in FIG. 4 into that shown in FIG. 3 (i.e., normal state or non-braking state).

Alternatively, the actuator 42 may be a solenoid or a press cylinder. If this occurs, rotation of the actuating shaft 44 is not required.

In view of the above, to prevent rotation of the brake disk 200, it is only necessary to simply operate the actuator 42, thereby resulting in convenience during use of the electric parking caliper 100, especially, when the vehicle is parked on a slope.

With this invention thus explained, it is apparent that numerous modifications and variations can be made without departing from the scope and spirit of this invention. It is therefore intended that this invention be limited only as indicated by the appended claims.

I claim:

1. An electric parking caliper adapted to connect with a brake disk, said brake disk having opposite first and second side surfaces perpendicular to an axis, said electric parking caliper comprising:
a caliper body unit including a first side member adapted to correspond with the first end surface, and a second member adapted to correspond with the second end surface and connected to said first side member, said first side member having a first groove adapted to be disposed in proximity to the first end surface, said second side member having a second groove adapted to be disposed in proximity to the second end surface;
a brake lining unit including a first positioning member movable in said first groove in a direction parallel to the axis, a first brake lining connected fixedly to said first positioning member, a second positioning member movable in said second groove in a direction parallel to the axis, and a second brake lining connected fixedly to said second positioning member, said first and second brake linings being adapted to be in proximity to the first and second end surfaces, respectively;
a driving unit including a first driving member movable in said first groove along a central line parallel to the axis, a second driving member movable in said second groove along the central line, a plurality of driving rods connected between said first and second driving members and adapted to be parallel to the axis, and a plurality of resilient members for biasing said first and second brake linings, each of said driving rods having a positioning end positioned on said second driving member, and a pulling end opposite to said positioning end, said resilient members being configured to bias said first and second brake linings away from the first and second end surfaces, respectively; and
an actuating unit including an actuator connected to said pulling ends of said driving rods, and an actuating shaft extending along the central line and driven by said actuator, said actuating shaft being movable for driving movement of said first driving member along the central line so as to move said first brake lining toward or away from the first end surface, and for activating said driving rods to move said second driving member along the central line so as to move said second brake lining toward or away from the second end surface.

2. The electric parking caliper as claimed in claim 1, wherein said actuating unit further includes a support connected with said pulling ends of said driving rods, said actuator being installed on said support, said actuating shaft extending through said support along the central line.

3. The electric parking caliper as claimed in claim 2, wherein said actuating unit further includes a bushing positioned on said support, said actuating shaft being disposed rotatably within said bushing.

4. The electric parking caliper as claimed in claim 3, wherein said bushing of said actuating unit has an annular flange, said first driving member having an insert tube portion extending into said first side member and said annular flange of said bushing along the central line.

5. The electric parking caliper as claimed in claim 1, wherein said actuator of said actuating unit includes an output shaft, said actuating shaft having a threaded portion, said first driving member having a threaded hole engaging the threaded portion of said actuating shaft.

6. The electric parking caliper as claimed in claim 1, wherein said resilient members are configured as compression springs, and are sleeved respectively on said driving rods, each of said resilient members having two ends abutting respectively against said first and second driving members.
